(19) United States
(12) Patent Application Publication
(10) Pub. No.: US 2017/0153496 A1
(43) Pub. Date: Jun. 1, 2017

(54) MANUFACTURE METHOD OF POLARIZATION AND COLOR FILTER FUNCTION INTEGRATION FILM AND LIQUID CRYSTAL DISPLAY PANEL

(71) Applicant: Shenzhen China Star Optoelectronics Technology Co. Ltd., Shenzhen, Guangdong (CN)

(72) Inventor: Ji Li, Shenzhen City (CN)

(21) Appl. No.: 14/786,162

(22) PCT Filed: Aug. 24, 2015
(86) PCT No.: PCT/CN2015/087960

§ 371 Date: Oct. 21, 2015

(30) Foreign Application Priority Data
Aug. 11, 2015 (CN) 201510489965.6

(51) Int. Cl. G02F 1/1335; C09B 29/01; G02F 1/1368; C09B 1/42; G02F 1/1339; G02F 1/1337

(52) U.S. Cl. CPC G02F 1/133533; G02F 1/133512; G02F 1/1339; G02F 1/1337; G02F 1/1368; G02F 1/133516; C09B 1/42; C09B 29/0003; G02F 2001/133521

(57) ABSTRACT

The present invention provides a manufacture method of a polarization and color filter function integration film and a liquid crystal display panel. The polarization and color filter function integration film obtained by the manufacture method possesses polarization property and color filter function. When the polarization and color filter function integration film is applied in the liquid crystal display panel, it can replace the lower substrate and the RGB color resist layer in the liquid crystal display panel according to prior art, which largely simplifies the production process, and saves the production cost to build the merits of cost reduction. The liquid crystal display panel of the present invention replaces the lower substrate and the RGB color resist layer in the liquid crystal display panel according to prior art with the polarization and color filter function integration film possessing polarization property and color filter function, which largely simplifies the production process, and saves the production cost.

### FIELD OF THE INVENTION

The present invention relates to a display technology field, and more particularly to a manufacture method of a polarization and color filter function integration film and a liquid crystal display panel comprising the polarization and color filter function integration film.

### BACKGROUND OF THE INVENTION

The LCD (Liquid Crystal Display) possesses advantages of thin body, power saving and no radiation to be widely used in many application scope. Most of the liquid crystal displays on the present market are back light type liquid crystal display devices, which comprise a liquid crystal display panel and a back light module. Generally, the liquid crystal display panel comprises a CF (Color Filter) substrate, a TFT (Thin Film Transistor) substrate, LC (Liquid Crystal) sandwiched between the CF substrate and TFT substrate and sealant. The formation process generally comprises: a forepart Array process (thin film, photo, etching and stripping), a middle Cell process (Lamination of the Thin Film Transistor substrate and the Color Filter substrate) and a post module assembly process (Attachment of the driving circuit IC and the printed circuit board). The forepart Array process is mainly to form the Thin Film Transistor substrate for controlling the movement of the liquid crystal molecules; the middle Cell process is mainly to add liquid crystal between the Thin Film Transistor substrate and the Color Filter substrate; the post module assembly process is mainly the driving circuit attachment and the integration of the printed circuit board. Thus, the liquid crystal molecules are driven to rotate to display pictures.

The working principle of the liquid crystal display panel is to locate liquid crystal molecules between two parallel glass substrates. By applying driving voltages to control whether the liquid crystal molecules to be changed directions, and changing the polarization of the light of the backlight module, and achieving the penetration or stop of the light path with the polarizers located at two sides of the liquid crystal display panel, the objective of controlling the transmission light volume can be realized; the RGB color resist layer filters and absorbs the light penetrating the liquid crystal layer so that the light of each pixel after leaving the color resist layer is fully constructed with the three primary colors (RGB). The various pixels correspondingly illuminate different colors. With the space color mixing principle, the full color display can be achieved. Obviously, the polarized light and the RGB three primary colors are the most important two factors for realizing the display theory.

The commonly used polarizer according to prior art only has polarization function. It mainly has iodine series and dye series. The manufacture principle is to soak a high polymer film of polyvinyl alcohol (PVA) in a solution of polyvalent iodide ion or polarization dye, and then, the PVA high polymer molecules are stretched in single axis; the PVA high polymer molecules are aligned in one direction after being stretched to align the iodine molecules or dye molecules which are adsorbed on the PVA molecules in the same direction; the long thin iodine molecules or dye molecules after being stretched will absorb the light which oscillates parallel with the long axis direction of the iodine molecules, and allow the light which oscillates perpendicular to the long axis direction of the iodine molecules penetrate therethrough to obtain the polarizer capable of forming polarized light.

In the liquid crystal display panel according to prior art, the polarized light is formed by polarizers, and the RGB three primary colors are provided with the RGB color resist layer. It is required to use upper, lower, two polarizers and the RGB color resist layer has to be located on the TFT substrate or the CF substrate. The structure and process is complicated and the manufacture cost is high.

### SUMMARY OF THE INVENTION

An objective of the present invention is to provide a manufacture method of a polarization and color filter function integration film. The polarization and color filter function integration film obtained by the manufacture method possesses polarization property and color filter function. When the polarization and color filter function integration film is applied in the liquid crystal display panel, it can replace the lower substrate and the RGB color resist film in the liquid crystal display panel according to prior art, which largely simplifies the production process, and saves the production cost to build the merits of cost reduction.

Another objective of the present invention is to provide a liquid crystal display panel to replace the lower substrate and the RGB color resist film in the liquid crystal display panel according to prior art with the polarization and color filter function integration film possessing polarization property and color filter function, which largely simplifies the production process, and saves the production cost, and saves the production cost to build the merits of cost reduction.

For realizing the aforesaid objective, the present invention provides a manufacture method of a polarization and color filter function integration film, comprising steps of:
step 1, providing dichroic dyes, polyvinyl alcohol and solvent to dissolve the dichroic dyes and the polyvinyl alcohol in the solvent to form ink jet fluid;
the dichroic dyes comprises red dichroic dye, green dichroic dye and blue dichroic dye, to respectively form red ink jet fluid, green ink jet fluid and blue ink jet fluid;
step 2, providing a substrate, and jet printing the red ink jet fluid, the green ink jet fluid and the blue ink jet fluid on the substrate according to a predetermined sub pixel pattern to form a dye film having a red sub pixel pattern, a green sub pixel pattern and a blue sub pixel pattern;
step 3, pre-curing the dye film to remove most solvent in the film;
step 4, performing rubbing process to the dye film, to make molecules of the dichroic dyes in the dye film orientated in a direction of rubbing along molecules of the polyvinyl alcohol with a mechanical alignment force of rubbing;
step 5, curing and solidifying the dye film in advance to obtain the polarization and color filter function integration film.

In the step 1, the dichroic dyes are azo colourants or anthraquinone dyes;
a molecular architecture of the anthraquinone dye is

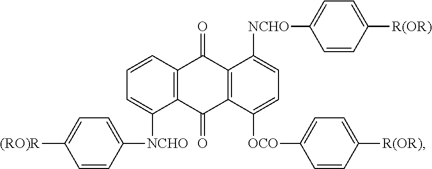

wherein R is a saturated or unsaturated alkyl;
the azo colourants is single azo colourants, double azo colourants or multi azo colourants.

A molecular architecture of the single azo colourants is

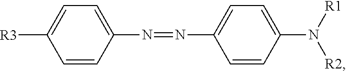

wherein R1, R2 are CH3, C2H5, C3H7 or C4H9, and R3 is NO2, C4H9, SO2, C3H7, Br, CN or NH2;
a molecular architecture of the double azo colourants is

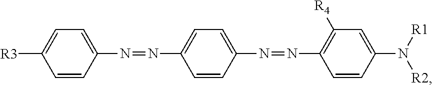

wherein R1, R2 are CH3, C2H5, C3H7 or C4H9, and R3 is NO2, C4H9, SO2, C3H7, Br, CN or NH2, and R4 is Cl, Br or CN;
a main chain structure of the multi azo colourants is azo colourants of which the main chain comprises three or more

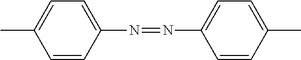

structures.

The present invention further provides a manufacture method of a polarization and color filter function integration film, comprising steps of:
step 1, coating a photosensitive polymer, and irradiating the photosensitive polymer with polarized ultraviolet light to make photochemical reaction occur to the photosensitive polymer to form an anisotropic photosensitive polymer film;
step 2, providing dichroic dyes and solvent to dissolve the dichroic dyes in the solvent to form dye solution;
the dichroic dyes comprises red dichroic dye, green dichroic dye and blue dichroic dye, to respectively form red dye solution, green dye solution and blue dye solution;
step 3, spray printing or coating the red dye solution, the green dye solution and the blue dye solution on the photosensitive polymer film according to a predetermined sub pixel pattern to form a dye film having a red sub pixel pattern, a green sub pixel pattern and a blue sub pixel pattern; the photosensitive polymer after light process in the photosensitive polymer film induces molecules of the dichroic dyes in the dye film to be orientated;
step 4, curing the dye film to remove the solvent in the film and solidifying the film to obtain the polarization and color filter function integration film.

In the step 1, the dichroic dyes are azo colourants or anthraquinone dyes;
a molecular architecture of the anthraquinone dye is

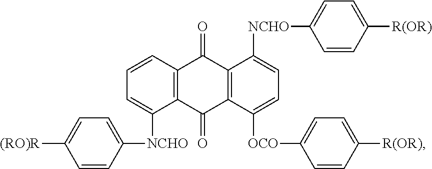

wherein R is a saturated or unsaturated alkyl;
the azo colourants is single azo colourants, double azo colourants or multi azo colourants.

A molecular architecture of the single azo colourants is

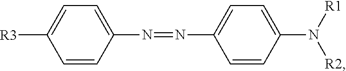

wherein R1, R2 are CH3, C2H5, C3H7 or C4H9, and R3 is NO2, C4H9, SO2, C3H7, Br, CN or NH2;
a molecular architecture of the double azo colourants is

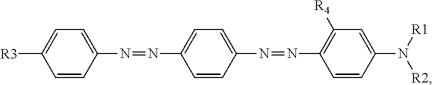

wherein R1, R2 are CH3, C2H5, C3H7 or C4H9, and R3 is NO2, C4H9, SO2, C3H7, Br, CN or NH2, and R4 is Cl, Br or CN;
a main chain structure of the multi azo colourants is azo colourants of which the main chain comprises three or more

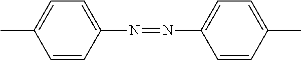

structures.

The present invention further provides a liquid crystal display panel, comprising an upper substrate and a lower substrate which are oppositely located, an upper polarizer located on the upper substrate, and a liquid crystal layer located between the upper substrate and the lower substrate;
the upper substrate comprises a first substrate, a black matrix located on the first substrate, photospacers located on the black matrix, a common electrode located on the first substrate and the black matrix and a first alignment film located on the common electrode;
the lower substrate comprises a second substrate, a thin film transistor layer located on the second substrate and a polarization and color filter function integration film on a passivation layer on the thin film transistor layer, pixel electrodes located on the polarization and color filter function integration film and a second alignment layer located on the pixel electrodes.

A flat layer is provided between the passivation layer and the polarization and color filter function integration film.

The polarization and color filter function integration film comprises a red sub pixel pattern, a green sub pixel pattern and a blue sub pixel pattern, and material of the red sub pixel pattern is a mixture of red dichroic dye and polyvinyl alcohol, and material of the green sub pixel pattern is a mixture of green dichroic dye and polyvinyl alcohol, and material of the blue sub pixel pattern is a mixture of blue dichroic dye and polyvinyl alcohol.

The polarization and color filter function integration film comprises a photosensitive polymer film and a dye film located on the photosensitive polymer film, and the dye film comprises a red sub pixel pattern, a green sub pixel pattern and a blue sub pixel pattern, and material of the red sub pixel pattern is red dichroic dye, and material of the green sub pixel pattern is green dichroic dye, and material of the blue sub pixel pattern is blue dichroic dye.

The benefits of the present invention are: the present invention provides a manufacture method of a polarization and color filter function integration film and a liquid crystal display panel having the polarization and color filter function integration film. The polarization and color filter function integration film obtained by the manufacture method possesses polarization property and color filter function. When the polarization and color filter function integration film is applied in the liquid crystal display panel, it can replace the lower substrate and the RGB color resist layer in the liquid crystal display panel according to prior art, which largely simplifies the production process, and saves the production cost to build the merits of cost reduction. The liquid crystal display panel provided by the present invention replaces the lower substrate and the RGB color resist layer in the liquid crystal display panel according to prior art with the polarization and color filter function integration film possessing polarization property and color filter function, which largely simplifies the production process, and saves the production cost, and saves the production cost to build the merits of cost reduction.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a flowchart of a manufacture method of a polarization and color filter function integration film according to the present invention;

FIG. 2 is a diagram of the step 2 of the manufacture method of the polarization and color filter function integration film in FIG. 1;

FIG. 3 is a diagram of the step 4 of the manufacture method of the polarization and color filter function integration film in FIG. 1;

FIG. 4 is a flowchart of another manufacture method of a polarization and color filter function integration film according to the present invention;

FIG. 5 is a sectional structure diagram of a first embodiment according to the liquid crystal display panel of the present invention;

FIG. 6 is a sectional structure diagram of a second embodiment according to the liquid crystal display panel of the present invention.

### DETAILED DESCRIPTION OF PREFERRED EMBODIMENTS

For better explaining the technical solution and the effect of the present invention, the present invention will be further described in detail with the accompanying drawings and the specific embodiments.

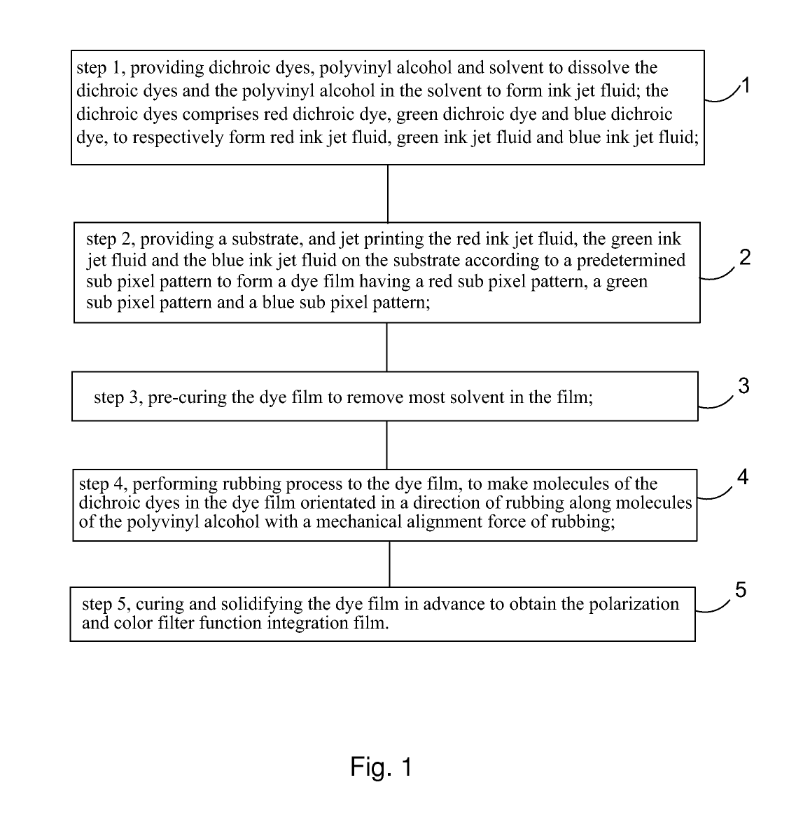

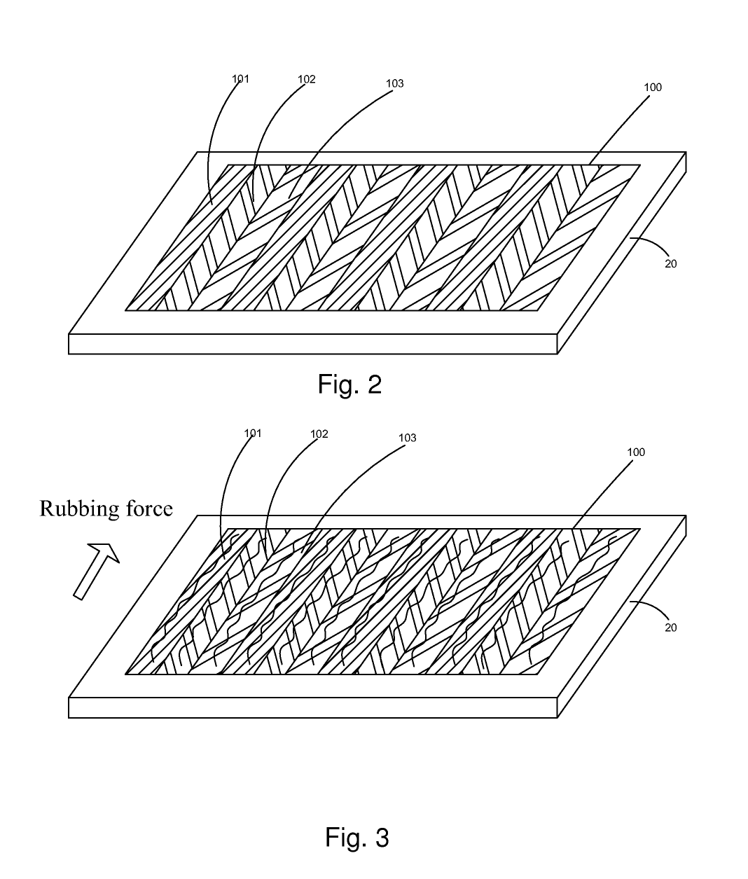

Please refer to FIG. 1. The present invention first provides a manufacture method of a polarization and color filter function integration film, comprising steps of:
step 1, providing dichroic dyes, polyvinyl alcohol and solvent to dissolve the dichroic dyes and the polyvinyl alcohol in the solvent to form ink jet fluid;
the dichroic dyes comprises red dichroic dye, green dichroic dye and blue dichroic dye, to respectively form red ink jet fluid, green ink jet fluid and blue ink jet fluid;
step 2, as shown in FIG. 2, providing a substrate 20, and jet printing the red ink jet fluid, the green ink jet fluid and the blue ink jet fluid on the substrate according to a predetermined sub pixel pattern to form a dye film 100 having a red sub pixel pattern 101, a green sub pixel pattern 102 and a blue sub pixel pattern 103;
specifically, the substrate 20 can be a TFT substrate;
step 3, pre-curing the dye film 100 to remove most solvent in the film;
step 4, as shown in FIG. 3, performing rubbing process to the dye film 100, to make molecules of the dichroic dyes in the dye film 100 orientated in a direction of rubbing along molecules of the polyvinyl alcohol with a mechanical alignment force of rubbing;
step 5, curing and solidifying the dye film 100 in advance to obtain the polarization and color filter function integration film.

Specifically, in the step 1, the dichroic dyes are azo colourants or anthraquinone dyes;
the anthraquinone dye is a chemical compound of which the main structure comprises

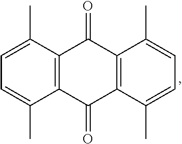 [SMILES: Cc1ccc(C)c2c1C(=O)c1c(C)ccc(C)c1C2=O]

and furthermore, a molecular architecture of the anthraquinone dye can be

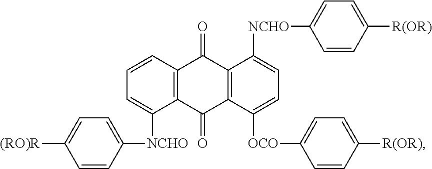

wherein R is a saturated or unsaturated alkyl;
the azo colourants is single azo colourants, double azo colourants or multi azo colourants.

Specifically, a molecular architecture of the single azo colourants is

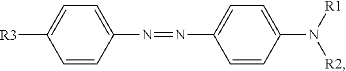

wherein R1, R2 are CH3, C2H5, C3H7 or C4H9, and R3 is NO2, C4H9, SO2, C3H7, Br, CN or NH2.

Specifically, a molecular architecture of the double azo colourants is

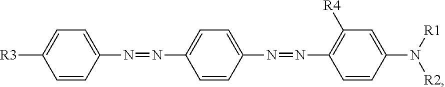

wherein R1, R2 are CH3, C2H5, C3H7 or C4H9, and R3 is NO2, C4H9, SO2, C3H7, Br, CN or NH2, and R4 is Cl, Br or CN.

Specifically, a main chain structure of the multi azo colourants is azo colourants of which the main chain comprises three or more

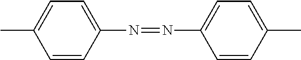

structures.

Based on the aforesaid manufacture method of the polarization and color filter function integration film, the present invention further provides a polarization and color filter function integration film, comprising a red sub pixel pattern 101, a green sub pixel pattern 102 and a blue sub pixel pattern 103, and material of the red sub pixel pattern 101 is a mixture of red dichroic dye and polyvinyl alcohol, and material of the green sub pixel pattern 102 is a mixture of green dichroic dye and polyvinyl alcohol, and material of the blue sub pixel pattern 103 is a mixture of blue dichroic dye and polyvinyl alcohol.

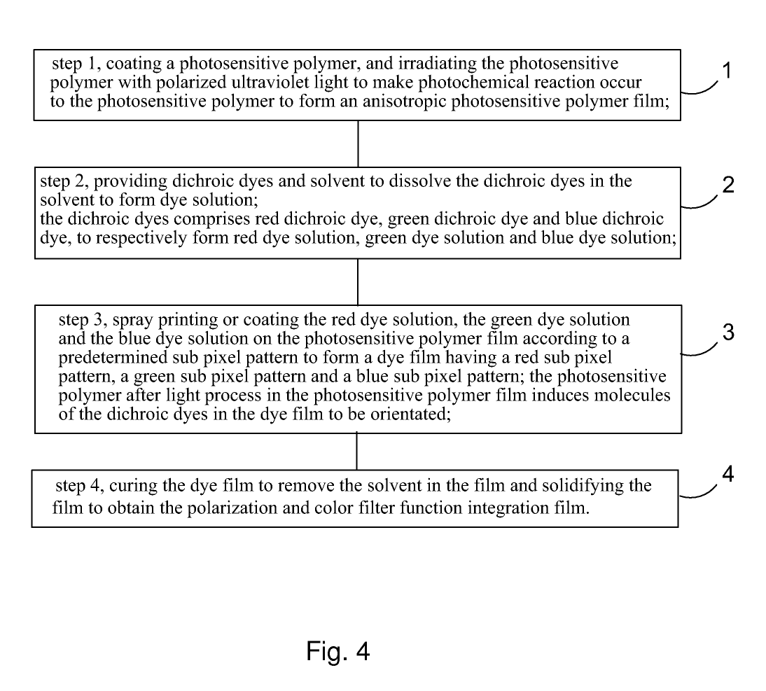

Please refer to FIG. 4. The present invention further provides a manufacture method of a polarization and color filter function integration film, comprising steps of:
step 1, coating a photosensitive polymer, and irradiating the photosensitive polymer with polarized ultraviolet light to make photochemical reaction occur to the photosensitive polymer to form an anisotropic photosensitive polymer film;
preferably, the photosensitive polymer is polyvinyl alcohol (PVA);
step 2, providing dichroic dyes and solvent to dissolve the dichroic dyes in the solvent to form dye solution;
the dichroic dyes comprises red dichroic dye, green dichroic dye and blue dichroic dye, to respectively form red dye solution, green dye solution and blue dye solution;
step 3, spray printing or coating the red dye solution, the green dye solution and the blue dye solution on the photosensitive polymer film according to a predetermined sub pixel pattern to form a dye film having a red sub pixel pattern, a green sub pixel pattern and a blue sub pixel pattern; the photosensitive polymer after light process in the photosensitive polymer film induces molecules of the dichroic dyes in the dye film to be orientated;
step 4, curing the dye film to remove the solvent in the film and solidifying the film to obtain the polarization and color filter function integration film.

Specifically, in the step 1, the dichroic dyes are azo colourants or anthraquinone dyes;
the anthraquinone dye is a chemical compound of which the main molecule structure comprises

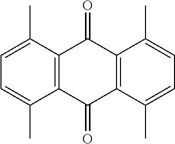 [SMILES: Cc1ccc(C)c2c1C(=O)c1c(C)ccc(C)c1C2=O]

structure, and furthermore, a molecular architecture of the anthraquinone dye is

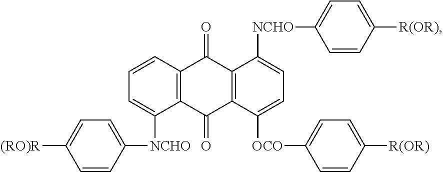

wherein R is a saturated or unsaturated alkyl;
the azo colourants is single azo colourants, double azo colourants or multi azo colourants.

Specifically, a molecular architecture of the single azo colourants is

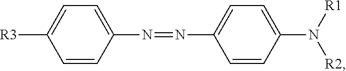

wherein R1, R2 are CH3, C2H5, C3H7 or C4H9, and R3 is NO2, C4H9, SO2, C3H7, Br, CN or NH2.

Specifically, a molecular architecture of the double azo colourants is

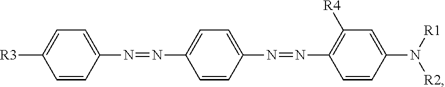

wherein R1, R2 are CH3, C2H5, C3H7 or C4H9, and R3 is NO2, C4H9, SO2, C3H7, Br, CN or NH2, and R4 is Cl, Br or CN.

Specifically, a main chain structure of the multi azo colourants is azo colourants of which the main chain comprises three or more

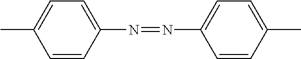

structures.

Based on the aforesaid manufacture method of the polarization and color filter function integration film, the present invention further provides a polarization and color filter function integration film, comprising a photosensitive polymer film and a dye film located on the photosensitive polymer film, and the dye film comprises a red sub pixel pattern, a green sub pixel pattern and a blue sub pixel pattern, and material of the red sub pixel pattern is red dichroic dye, and material of the green sub pixel pattern is green dichroic dye, and material of the blue sub pixel pattern is blue dichroic dye.

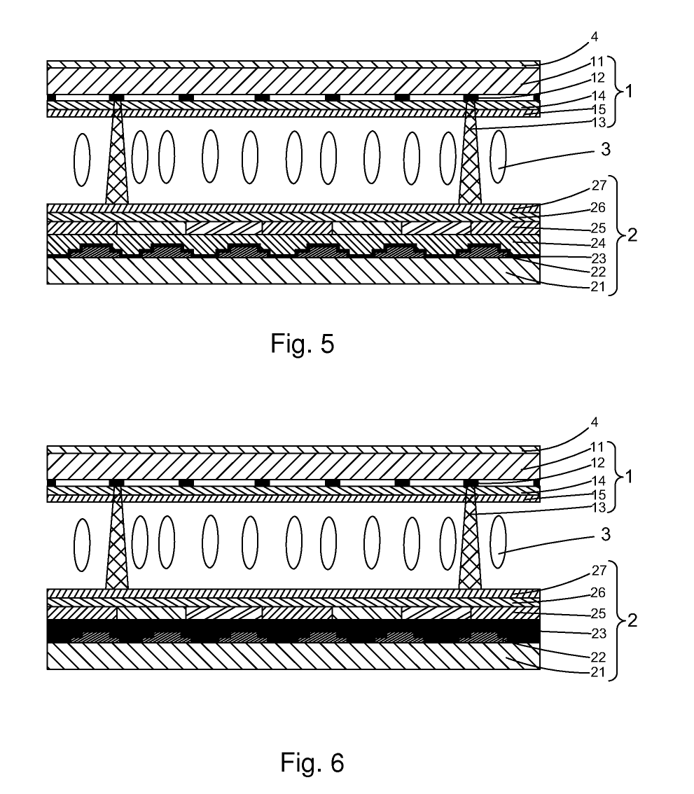

Please refer to FIG. 5, which is the first embodiment of the present invention. The liquid crystal display panel comprises an upper substrate 1 and a lower substrate 2 which are oppositely located, an upper polarizer 4 located on the upper substrate 1, and a liquid crystal layer 3 located between the upper substrate 1 and the lower substrate 2.

Specifically, the upper substrate 1 comprises a first substrate 11, a black matrix 12 located on the first substrate 11, photospacers 13 located on the black matrix 12, a common electrode 14 located on the first substrate 11 and the black matrix 12 and a first alignment film 15 located on the common electrode 14;
the lower substrate 2 comprises a second substrate 21, a thin film transistor layer 22 located on the second substrate 21, a passivation layer 23 located on the thin film transistor layer 22, a flat layer 24 located on the passivation layer 23, a polarization and color filter function integration film 25 located on flat layer 24, pixel electrodes 26 located on the polarization and color filter function integration film 25 and a second alignment layer 27 located on the pixel electrodes 26.

Specifically, the polarization and color filter function integration film 25 can be one of the following two structures:

(I) the polarization and color filter function integration film 25 comprises a red sub pixel pattern, a green sub pixel pattern and a blue sub pixel pattern, and material of the red sub pixel pattern is a mixture of red dichroic dye and polyvinyl alcohol, and material of the green sub pixel pattern is a mixture of green dichroic dye and polyvinyl alcohol, and material of the blue sub pixel pattern is a mixture of blue dichroic dye and polyvinyl alcohol.

(II) the polarization and color filter function integration film 25 comprises a photosensitive polymer film and a dye film located on the photosensitive polymer film, and the dye film comprises a red sub pixel pattern, a green sub pixel pattern and a blue sub pixel pattern, and material of the red sub pixel pattern is red dichroic dye, and material of the green sub pixel pattern is green dichroic dye, and material of the blue sub pixel pattern is blue dichroic dye.

Specifically, both the first substrate 11 and the second substrate 21 are glass substrates.

Please refer to FIG. 6, which is the second embodiment of the liquid crystal display panel according to the present invention. In comparison with the first embodiment, the difference is that only the passivation layer 23 is provided between the thin film transistor layer 22 and the polarization and color filter function integration film 25 without the flat layer 24. The thickness of the passivation layer 23 is larger, and functions for planarization while protecting the thin film transistor layer 22.

In conclusion, the present invention provides a manufacture method of a polarization and color filter function integration film and a liquid crystal display panel having the polarization and color filter function integration film. The polarization and color filter function integration film obtained by the manufacture method possesses polarization property and color filter function. When the polarization and color filter function integration film is applied in the liquid crystal display panel, it can replace the lower substrate and the RGB color resist layer in the liquid crystal display panel according to prior art, which largely simplifies the production process, and saves the production cost to build the merits of cost reduction. The liquid crystal display panel provided by the present invention replaces the lower substrate and the RGB color resist layer in the liquid crystal display panel according to prior art with the polarization and color filter function integration film possessing polarization property and color filter function, which largely simplifies the production process, and saves the production cost, and saves the production cost to build the merits of cost reduction.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A manufacture method of a polarization and color filter function integration film, comprising steps of:
step 1, providing dichroic dyes, polyvinyl alcohol and solvent to dissolve the dichroic dyes and the polyvinyl alcohol in the solvent to form ink jet fluid;
the dichroic dyes comprises red dichroic dye, green dichroic dye and blue dichroic dye, to respectively form red ink jet fluid, green ink jet fluid and blue ink jet fluid;
step 2, providing a substrate, and jet printing the red ink jet fluid, the green ink jet fluid and the blue ink jet fluid on the substrate according to a predetermined sub pixel pattern to form a dye film having a red sub pixel pattern, a green sub pixel pattern and a blue sub pixel pattern;
step 3, pre-curing the dye film to remove most solvent in the film;
step 4, performing rubbing process to the dye film, to make molecules of the dichroic dyes in the dye film orientated in a direction of rubbing along molecules of the polyvinyl alcohol with a mechanical alignment force of rubbing;
step 5, curing and solidifying the dye film in advance to obtain the polarization and color filter function integration film.

2. The manufacture method of the polarization and color filter function integration film according to claim 1, wherein in the step 1, the dichroic dyes are azo colourants or anthraquinone dyes;
a molecular architecture of the anthraquinone dye is 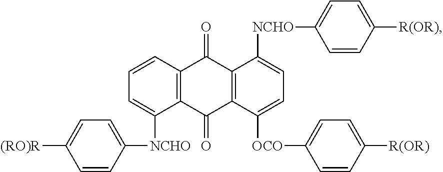
wherein R is a saturated or unsaturated alkyl;
the azo colourants is single azo colourants, double azo colourants or multi azo colourants.

3. The manufacture method of the polarization and color filter function integration film according to claim 2, wherein a molecular architecture of the single azo colourants is 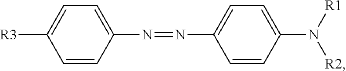
wherein R1, R2 are CH3, C2H5, C3H7 or C4H9, and R3 is NO2, C4H9, SO2, C3H7, Br, CN or NH2;
a molecular architecture of the double azo colourants is 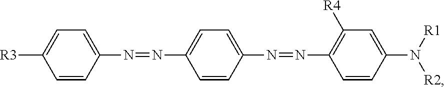
wherein R1, R2 are CH3, C2H5, C3H7 or C4H9, and R3 is NO2, C4H9, SO2, C3H7, Br, CN or NH2, and R4 is Cl, Br or CN;
a main chain structure of the multi azo colourants is azo colourants of which the main chain comprises three or more 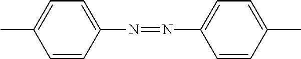
structures.

4. A manufacture method of a polarization and color filter function integration film, comprising steps of:
step 1, coating a photosensitive polymer, and irradiating the photosensitive polymer with polarized ultraviolet light to make photochemical reaction occur to the photosensitive polymer to form an anisotropic photosensitive polymer film;
step 2, providing dichroic dyes and solvent to dissolve the dichroic dyes in the solvent to form dye solution;
the dichroic dyes comprises red dichroic dye, green dichroic dye and blue dichroic dye, to respectively form red dye solution, green dye solution and blue dye solution;
step 3, spray printing or coating the red dye solution, the green dye solution and the blue dye solution on the photosensitive polymer film according to a predetermined sub pixel pattern to form a dye film having a red sub pixel pattern, a green sub pixel pattern and a blue sub pixel pattern; the photosensitive polymer after light process in the photosensitive polymer film induces molecules of the dichroic dyes in the dye film to be orientated;
step 4, curing the dye film to remove the solvent in the film and solidifying the film to obtain the polarization and color filter function integration film.

5. The manufacture method of the polarization and color filter function integration film according to claim 4, wherein in the step 1, the dichroic dyes are azo colourants or anthraquinone dyes;
a molecular architecture of the anthraquinone dye is 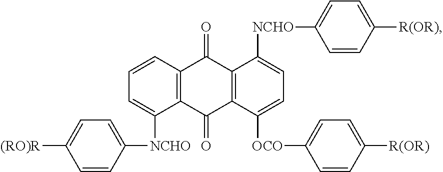
wherein R is a saturated or unsaturated alkyl;
the azo colourants is single azo colourants, double azo colourants or multi azo colourants.

6. The manufacture method of the polarization and color filter function integration film according to claim 5, wherein a molecular architecture of the single azo colourants is 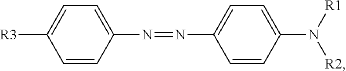
wherein R1, R2 are CH3, C2H5, C3H7 or C4H9, and R3 is NO2, C4H9, SO2, C3H7, Br, CN or NH2;
a molecular architecture of the double azo colourants is 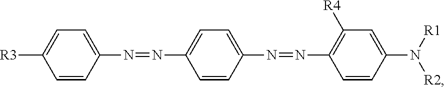
wherein R1, R2 are CH3, C2H5, C3H7 or C4H9, and R3 is NO2, C4H9, SO2, C3H7, Br, CN or NH2, and R4 is Cl, Br or CN;
a main chain structure of the multi azo colourants is azo colourants of which the main chain comprises three or more 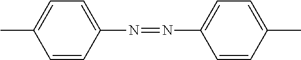
structures.

7. A liquid crystal display panel, comprising an upper substrate and a lower substrate which are oppositely located, an upper polarizer located on the upper substrate, and a liquid crystal layer located between the upper substrate and the lower substrate;
the upper substrate comprises a first substrate, a black matrix located on the first substrate, photospacers located on the black matrix, a common electrode located on the first substrate and the black matrix and a first alignment film located on the common electrode;
the lower substrate comprises a second substrate, a thin film transistor layer located on the second substrate and a polarization and color filter function integration film on a passivation layer on the thin film transistor layer, pixel electrodes located on the polarization and color filter function integration film and a second alignment layer located on the pixel electrodes.

8. The liquid crystal display panel according to claim 7, wherein a flat layer is provided between the passivation layer and the polarization and color filter function integration film.

9. The liquid crystal display panel according to claim 7, wherein the polarization and color filter function integration film comprises a red sub pixel pattern, a green sub pixel pattern and a blue sub pixel pattern, and material of the red sub pixel pattern is a mixture of red dichroic dye and polyvinyl alcohol, and material of the green sub pixel pattern is a mixture of green dichroic dye and polyvinyl alcohol, and material of the blue sub pixel pattern is a mixture of blue dichroic dye and polyvinyl alcohol.

10. The liquid crystal display panel according to claim 7, wherein the polarization and color filter function integration film comprises a photosensitive polymer film and a dye film located on the photosensitive polymer film, and the dye film comprises a red sub pixel pattern, a green sub pixel pattern and a blue sub pixel pattern, and material of the red sub pixel pattern is red dichroic dye, and material of the green sub pixel pattern is green dichroic dye, and material of the blue sub pixel pattern is blue dichroic dye.
